(19) United States
(12) Patent Application Publication
(10) Pub. No.: US 2021/0294328 A1
(43) Pub. Date: Sep. 23, 2021

(54) SYSTEMS AND METHODS FOR DETERMINING A POSE OF A SENSOR ON A ROBOT

(71) Applicant: Brain Corporation, San Diego, CA (US)

(72) Inventor: Sahil Dhayalkar, San Diego, CA (US)

(21) Appl. No.: 17/206,940

(22) Filed: Mar. 19, 2021

Related U.S. Application Data
(60) Provisional application No. 62/992,621, filed on Mar. 20, 2020.

(51) Int. Cl. G05D 1/02

(52) U.S. Cl. CPC G05D 1/021

(57) ABSTRACT

Systems and methods for determining a pose of a sensor on a robot are disclosed herein. According to at least one non-limiting exemplary embodiment, a pose of a sensor may be determined with respect to a base link frame origin based on a measured discrepancy between localization data of an object by the sensor and another sensor, the discrepancy corresponding to an error in a pose of the sensor. Pose graph optimization may further be utilized to calibrate all sensors of a robot using digital transformations or may be utilized to diagnose errors in poses of one or more sensors.

### CROSS-REFERENCE TO RELATED APPLICATIONS

The present application claims priority to U.S. Provisional Application No. 62/992,621, filed on Mar. 20, 2020, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for determining a pose of a sensor on a robot.

### SUMMARY

The foregoing needs are satisfied by the present disclosure, which provides for, inter alia, systems and methods for determining a pose of a sensor on a robot. The present disclosure is directed towards a practical application of determining poses of sensors on a robot such that the sensors, or data arriving from the sensors, may be calibrated or adjusted. Calibration of sensors of a robot may be crucial for safe, precise, and efficient navigation and operation of the robot, wherein measurement of poses of the sensors, or deviation of the poses from default poses, may be critical for calibration of the sensors.

Exemplary embodiments described herein have innovative features, no single one of which is indispensable or solely responsible for their desirable attributes. Without limiting the scope of the claims, some of the advantageous features will now be summarized.

According to at least one non-limiting exemplary embodiment, a method is disclosed. The method comprises: determining, via a controller of a robot, a sensor transformation matrix based on a scan matching between measurements of an object measured by a first sensor and a second sensor, the scan matching being performed within a base link frame of reference, the sensor transformation matrix comprising a spatial transformation between the base link frame and a local reference frame of the first sensor, the scan matching aligns measurements by the first sensor to match measurements of the second sensor; and applying, via the controller, a digital transformation to data arriving from the first sensor based on the sensor transformation matrix of the first sensor, the digital transformation configures measurements of the first sensor and second sensor of the object to match.

According to at least one non-limiting exemplary embodiment, the method further comprises: determining, via the controller, a pose graph based on the sensor transformation matrix of the first sensor, sensor transformation matrices of the second sensor, and a transformation between local origins of the first and second sensor; optimizing, via the controller, the pose graph to determine a pose of the first sensor and a pose of the second sensor; applying the digital transformation to the first sensor based on the pose of the first sensor determined by the pose graph optimization; and applying a second digital transformation to the second sensor based on the pose of the second sensor determined by the pose graph optimization.

According to at least one non-limiting exemplary embodiment, the pose graph is updated upon a threshold amount of additional data being collected by the first sensor and the second sensor, the threshold amount corresponding to a number of points.

According to at least one non-limiting exemplary embodiment, the method further comprises: constraining the pose graph optimization by imposing threshold constraints to translational and rotational pose parameters of the test and second sensors, the threshold constraints corresponding to a threshold deviation from a default pose.

According to at least one non-limiting exemplary embodiment, a method for calibrating range sensors on a robot is disclosed. The method comprises a controller of the robot: receiving a first measurement from a first range sensor and a second measurement from a second range sensor, both the first and second measurements include detection of at least one common object or surface; aligning, via a controller of the robot, the common object or surface of the first measurement to the same common object or surface in the second measurement to yield a scan match transform; and determining a first value of the pose of the first range sensor based on the scan match transform; and applying a digital transform on data arriving from the first range sensor such that incoming data from the first range sensor aligns with incoming data from the second range sensor.

According to at least one non-limiting exemplary embodiment, the first and second measurements are defined with respect to a base link frame of reference, the base link frame of reference being defined with respect to an origin point of the robot.

According to at least one non-limiting exemplary embodiment, the method further comprises the controller: aligning the first measurement to a third measurement from a third sensor on the robot to determine a second value for the pose of the first sensor, the third measurement senses the same object or surface within the first and second measurement, the alignment comprising aligning the same object or surface in the third measurement to its corresponding location in the second measurement; wherein the pose of the first sensor comprises an average of the first and second values of the pose of the first sensor.

According to at least one non-limiting exemplary embodiment, the method further comprises the controller: constructing a pose graph, the pose graph defines the location of the first, second, and third sensors with respect to the base link frame origin based on their determined pose values; and updating the pose graph upon the first, second, and third sensors generating new measurements by aligning the new measurements such that all three sensors agree on a location of a same object or surface.

According to at least one non-limiting exemplary embodiment, a non-transitory computer-readable storage medium having a plurality of instructions stored thereon is disclosed. The instructions, when executed by a controller of a robot, cause the controller to: determine sensor transformation matrix based on a scan matching between measurements of an object measured by a first sensor and a second sensor, the scan matching being performed within a base link frame of reference, the sensor transformation matrix comprising a spatial transformation between the base link frame and a local reference frame of the first sensor, the scan matching aligns measurements by the first sensor to match measurements of the second sensor; apply a digital transformation to data arriving from the first sensor based on the sensor transformation matrix of the first sensor, the digital transformation configures measurements of the first sensor and second sensor of the object to match; determine a pose graph based on the sensor transformation matrix of the first sensor, sensor transformation matrices of the second sensor, and a transformation between local origins of the first and second sensor; optimize the pose graph to determine a pose of the first sensor and a pose of the second sensor; applying the digital transformation to the first sensor based on the pose of the first sensor determined by the pose graph optimization; and apply a second digital transformation to the second sensor based on the pose of the second sensor determined by the pose graph optimization wherein the pose graph is updated upon a threshold amount of additional data being collected by the first sensor and the second sensor, the threshold amount corresponding to a number of points; and the pose graph optimization is constrained by imposing threshold constraints to translational and rotational pose parameters of the test and second sensors, the threshold constraints corresponding to a threshold deviation from a default pose.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some embodiments of this disclosure.

FIG. 1B is a functional block diagram of a controller or processing device in accordance with some embodiments of this disclosure.

FIG. 2A illustrates three reference frames in accordance with some embodiments of this disclosure.

FIG. 2B is a time of flight distance measuring sensor generating a point cloud of a wall in accordance with some embodiments of this disclosure.

FIG. 3A is a top view of a robot navigating a route within an environment and collecting measurements using two sensors, according to an exemplary embodiment.

FIG. 3B is a top view of a robot collecting measurements using two different sensors to localize nearby objects as the robot navigates a route, according to an exemplary embodiment,

FIG. 3C illustrates two scans captured by two sensors within a base link frame of reference to be utilized to determine an error in a pose of one of the two sensors, according to an exemplary embodiment.

FIG. 4A illustrates a method for determining a pose of a sensor on a robot, according to an exemplary embodiment.

FIG. 4B illustrates a robot determining an error in a pose of one of its sensors following the method of FIG. 4A, according to an exemplary embodiment.

FIG. 5A is a functional block diagram illustrating a controller of a robot determining poses for all sensors for use in calibrating one or more of the sensors, according to an exemplary embodiment.

FIG. 5B is a three-dimensional illustration of a pose graph based on a system illustrated in FIG. 5A, according to an exemplary embodiment.

FIG. 6A-C illustrates a scan matching process to determine a scan match transform matrix, according to an exemplary embodiment.

FIG. 7 illustrates a down sampling of measurements taken from a high-resolution sensor to a resolution of a low-resolution sensor for use in scan matching, according to an exemplary embodiment.

All Figures disclosed herein are © Copyright 2021 Brain Corporation. All rights reserved.

### DETAILED DESCRIPTION

Currently, robots may comprise a plurality of sensors configured to enable the robots to perceive their surroundings and perform tasks. Proper calibration of these sensors may be imperative to safe, precise, and efficient operation of the robots. Sensors on robots may initially be well calibrated in default positions (i.e., positions specified by a manufacturer of the robots), however, over time the positions of these sensors may change due to, for example, wear and tear, collisions experienced by the robot 102, bumps in a floor, or other perturbations. If a pose of a sensor is known at any point in time, digital transformations may be applied to correct data from these sensors within a reasonable tolerance. For example, if a sensor comprises an error of a few degrees (e.g., 5°) in its yaw orientation, a digital transformation may be calculated and applied to data from that sensor such that the transformed data may correspond to data of the sensor in its default (i.e., calibrated) orientation. That is, the data is transformed to appear to be measured from a well-calibrated sensor. Furthermore, if a pose of a sensor deviates from its default pose by a threshold amount, a robot may be configured to stop as a safety measure. Accordingly, there is a need in the art for systems and methods for determining a pose of a sensor on a robot in real time such that real-time calibration of these sensors may be implemented using digital transformations.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for determining a pose of a sensor on a robot. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway®, etc.), trailer movers, vehicles, and the like. Robots may also include any autonomous and/or semi-autonomous machine for transporting items, people, animals, cargo, freight, objects, luggage, and/or anything desirable from one location to another.

As used herein, a pose or position of a sensor or robot may comprise translational (x, y, z) coordinate locations as well as (roll, pitch, yaw) rotational position of the sensor with respect to an origin, wherein a pose may comprise some or all of the translational and/or rotational parameters.

As used herein, a default pose of a sensor may comprise a calibrated or ideal pose of the sensor determined by, for example, a manufacturer of a robot comprising the sensor.

As used herein, a transformation, spatial transformation, or transformation matrix may comprise a matrix which may be added or multiplied to a set of localization coordinates or data (e.g., points of a point cloud) within a first reference frame to redefine the same set localization coordinates or data in a second reference frame. For example, a transformation matrix may correspond to a mathematical representation of a change of coordinates from a first coordinate system defined about a first origin to a second coordinate system defined about a second origin, the first and second origins may be spatially separated by a constant or time-varying distance. Similarly, transformation matrices may be applied to data arriving from a sensor to adjust measurements collected by the sensor, wherein the adjustment is typically based on a difference between a pose of the sensor and its default pose. Transformation matrices may further denote a spatial difference in position between two objects, points, or locations within a single reference frame. That is, transformations, as used herein, include mathematical operations which adjust, manipulate, or change data from, e.g., one or more sensors of a robot to either (i) determine a spatial separation between two points, or (ii) change reference frames from being defined about a first origin to a different second origin point.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices, and application-specific integrated circuits (“ASICs”). Such digital processing devices may be contained on a single unitary integrated circuit die or distributed across multiple components.

As used herein, computer program and/or software may include any sequence of machine-cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to determine, in real time, poses of one or more of their sensors; (ii) enable robots to preform real time adjustments to sensors to enhance calibration; and (iii) enhance navigation and task performance of robots by enabling the robots to calibrate their own sensors. Other advantages are readily discernible by one having ordinary skill in the art given the contents of the present disclosure.

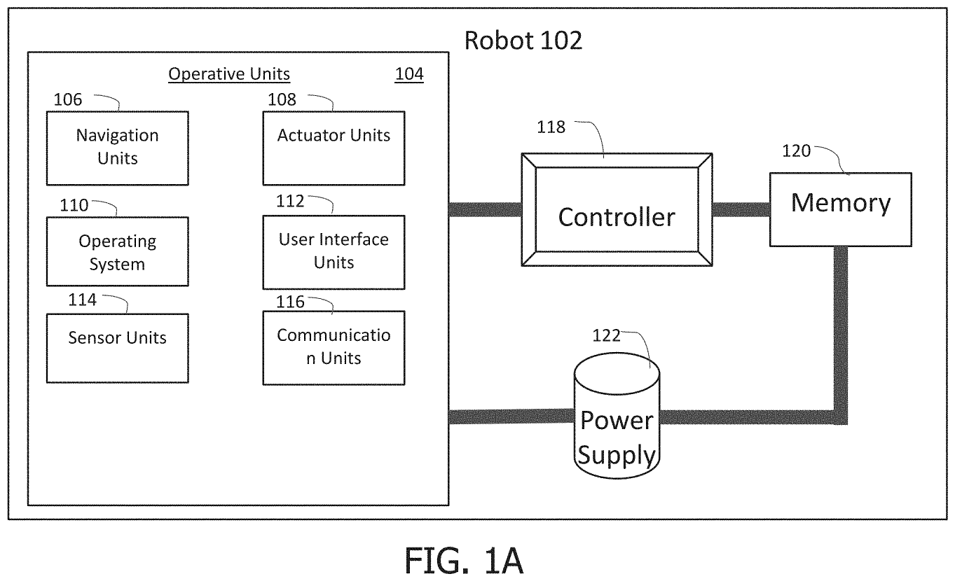

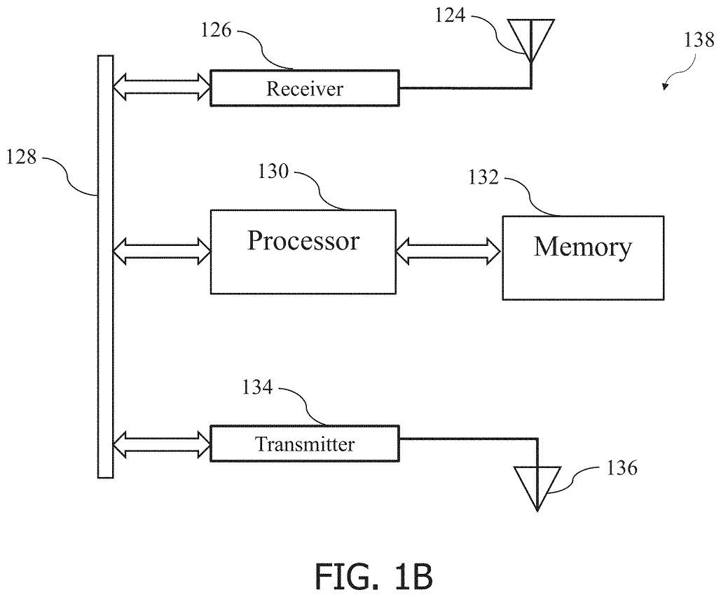

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, the actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field-programmable gate arrays (“FPGAs”)), a programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudo-static RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remotely from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off the frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off the frame, etc.), colors, surroundings, and/or other conditions. The number of images in the library may depend at least in part on one or more of the amount of available data, the variability of the surrounding environment in which robot 102 operates, the complexity of objects and/or people, the variability in the appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through a wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure the internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where the position may include robot's location, displacement, and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smartphones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium-ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation, or transformation illustrated in the figures below comprises a controller executing computer-readable instructions stored on a non-transitory computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

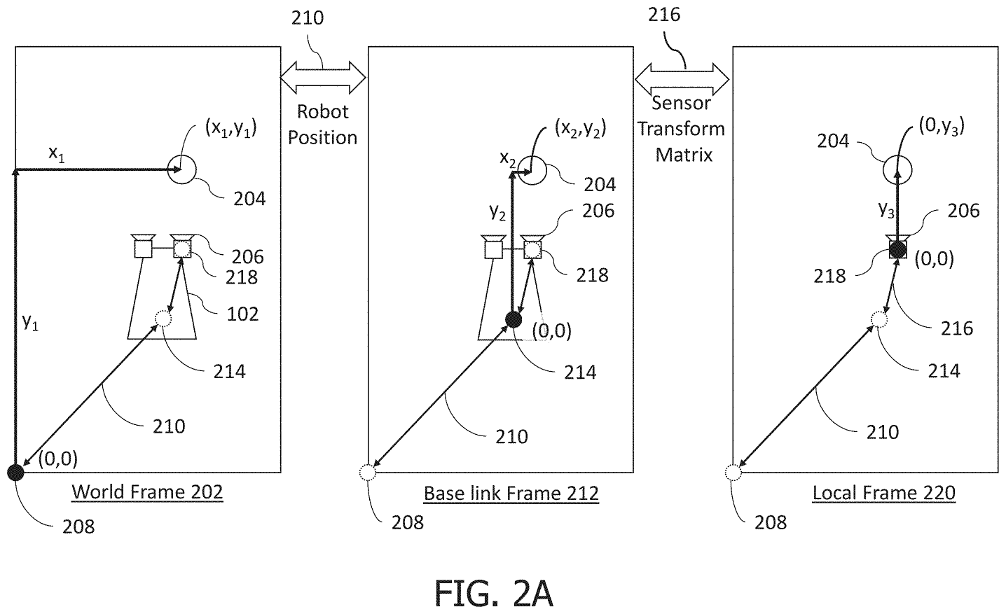

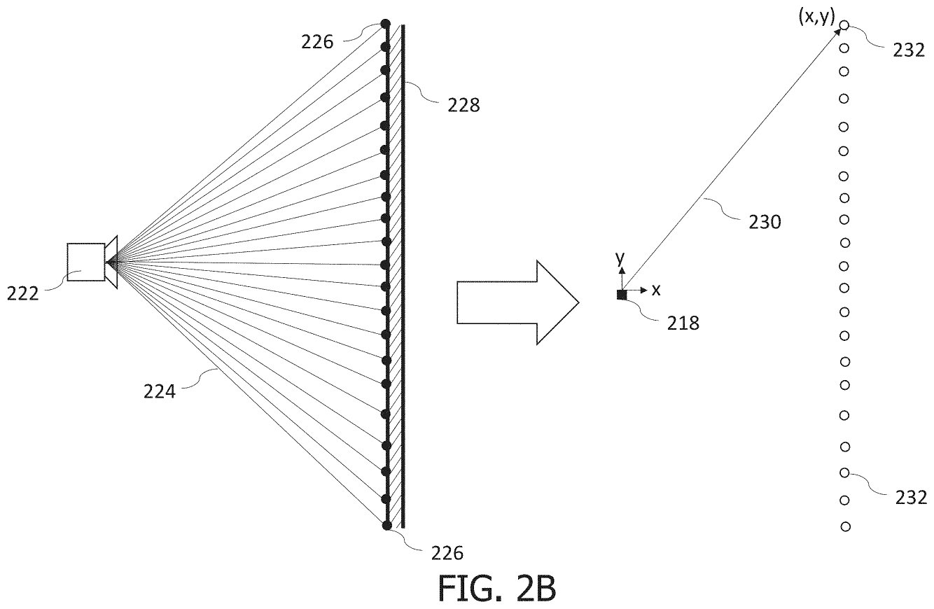

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer-readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processing devices 138 thereof executing computer-readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

FIG. 2A illustrates three reference frames 202, 212, 220 and transformations 210, 216 for moving between each reference frame in accordance with some embodiments of this disclosure. Beginning with world frame 202 depicted on the left, a world frame 202 comprises a reference frame with a fixed origin 208 located at a designated place within an environment of robot 102 from which all localization data is in reference to. The designated place may comprise, for example, a stationary landmark (e.g., an audible, visual, infrared, quick-response code, etc. marker or a feature of an environment) within an environment or a fixed point chosen arbitrarily. Localization of an object 204 within the world frame 202 comprises determining an x and y position (z position omitted for the two-dimensional illustration) of the object 204, denoted as x₁ and y₁, with respect to the origin 208 illustrated. A robot 102 may therefore localize the object 204, using one or both sensor(s) 206, at an (x, y) position of (x₁, y₁) within the world frame 202. It is appreciated by one skilled in the art that a reference frame may utilize a cartesian, polar, spherical, or other coordinate system for defining positions within the reference frame, wherein cartesian coordinate systems will be illustrated herein for clarity.

Next, a base link frame 212 is defined about an origin point 214 of the robot 102. The origin point 214 of the robot 102 may comprise a predetermined location on the robot 102 comprising a spatial location of (0, 0) within the base link frame 212. This point 214 may be located, for example, in a center between two rear wheels, at the center (e.g., geometric center or center of mass) of the robot 102, or any other designated location or feature of the robot 102. In some embodiments, the origin point 214 may be located outside of a footprint of (i.e., area occupied by) the robot 102. To determine positions of an object 204, localized at (x₁, y₁) within the world frame 202, within the base link frame 212, a position of the robot 102 with respect to world frame origin 208 may be utilized to determine a first transformation 210 comprising a spatial transformation of coordinates from the origin 208 to origin 214. Transformation 210 has been illustrated both as a spatial transformation within the illustrated reference frames 202, 212, and 220 and as a transition between the world frame 202 and base link frame 212. For example, the object 204 localized in the base link frame 212 may comprise positional coordinates of (x₂, y₂), wherein x₂ and y₂ are different values than x₁ and y₁ due to a change in a location of the origin from the location 208 to location 214 of the world frame 202 to the base link frame 212, respectively. A controller 118 of the robot 102 may utilize any conventional method(s) within the art, such as simultaneous localization and mapping (“SLAM”), to always localize the robot origin 214 with respect to world origin 208 during operation of the robot 102. If the position of the robot origin 214 with respect to the world frame origin 208 is known, transformation 210 may be mathematically determined, as appreciated by one skilled in the art.

Lastly, a local frame 220 comprises a reference frame with an origin defined about a designated origin point 218 of the sensor 206. As an example, this origin point 218 may comprise an origin from which LiDAR sensors measure distance with respect to (e.g., a distance of 5 meters comprises a 5-meter distance between the origin 218 and a target), such as origin 218 of sensor 222 illustrated in FIG. 2B below. To move from the base link frame 212 to the local frame 220, a sensor transform 216 may be applied to localization coordinates measured by controller 118. The sensor transform 216 comprises a spatial transformation of coordinates from an origin 214 of the base link frame 212 to an origin 218 of a sensor 206 based on a position of the origin 218 with respect to the origin 214 of the base link frame 212. This transformation 216 is dependent on a pose of the sensor 206, and thereby a pose of the sensor origin 218 with respect to the origin 214 of the base link frame 212. The sensor 206, within the local frame 220 of the sensor 206, may localize the object 204 at a position (0, y₃) with respect to the origin 218 of the local frame 220. In the example illustrated, x₁ is greater than x₂ which is greater than x₃ (i.e., 0). Similarly, y₁ is greater than y₂ which is greater than y₃ based on how these origins 208, 214, and 218 are defined, current position of the robot 102, and positions of the sensor 206 on the robot 102. However, this is not intended to be limited to the illustrated positions of origins 208, 214, 218. The sensor transform 216 may remain substantially constant in time if a pose of the sensor 206 on the robot 102 remains constant in time, unless the origin 218 of the sensor 206 is configured to move independently of the robot 102 (e.g., sensor 206 mounted on an extendable portion of robot 102 and/or coupled to an actuator unit 108). However, as robot 102 operates, typical wear and tear may cause the pose of the sensor 206 to change in time, wherein accurate measurement of the pose or changes to the pose of the sensor 206 may be required for safe and precise navigation and task performance by the robot 102. Accordingly, accurate measurement of transformation 216 between the base link frame origin 214 and sensor origin 218 is critical for online (i.e., real-time) operation of the robot 102 by ensuring its sensors are well calibrated.

One skilled in the art may appreciate that inverse transformations may be determined using an inverse of a respective transformation matrix 210 or 216 to move from a base link frame 212 to world frame 202 or from local frame 220 to base link frame 212, respectively. Additionally, one skilled in the art may appreciate that the sensor transformation matrix 216 may change over time as the robot 102 operates as a pose of the sensor 206 (i.e., pose of origin 218) may change over time due to, for example, wear and tear, collisions, or other perturbations experienced by the robot 102 during operation. If the sensor transform matrix 216 is known for any point in time, then digital transformations may be applied to data from the sensor 206 to correct any errors in sensor data due to an error in a pose of the sensor at any point in time. This correction may be performed as the robot 102 operates (e.g., by manipulating incoming data from sensor 206) or after the robot 102 operates (e.g., by, at a later time, adjusting positions of localized objects sensed during operation). Errors in a pose of a sensor 206 may comprise any deviation from a default pose of the sensor 206. The digital transformations applied to the data of sensor 206 may further change in time in accordance with the changes to the sensor transformation 216 over time to ensure the sensor data comprises minimal error. That is, a sensor transform 216 for a sensor corresponds to a pose sensor 206 relative to an origin 214 of a robot 102, wherein the pose of the sensor 206 may be compared to a default pose (i.e., ideal configuration) for calibration of the sensor 206 as further illustrated below. One skilled in the art may appreciate that a transformation 216 between the origin 214 and sensor 206 at its default pose remains constant over time.

FIG. 2B illustrates a planar light detection and ranging (“LiDAR”) sensor 222, an example of a sensor of sensor units 114, collecting distance measurements of a wall 228 along a measurement plane in accordance with some exemplary embodiments of the present disclosure. The distance measurements comprising a measured distance between an origin 218 of the sensor 222 and a target, the target in this embodiment being the wall 228. Planar LiDAR sensor 222 may be configured to collect distance measurements of the wall 228 by projecting a plurality of beams 224 of photons at discrete angles along the measurement plane and determining the distance of the wall 228 based on a time of flight (“TOF”) of the photon leaving the LiDAR sensor 222, reflecting off the wall 228, and returning back to a detector of the LiDAR sensor 222. A measurement plane of the LiDAR 222 comprises a plane along which the beams 224 are emitted which, for illustration of this exemplary embodiment, is the plane of the page. For a robot 102 operating in an environment, a measurement plane may be oriented, for example, horizontally and/or vertically in the environment. In some embodiments, the LiDAR sensor 222 may be coupled to one or more actuator units 108 to be configurable to adjust its measurement plane by adjusting its pose relative to the robot.

Individual beams 224 of photons may localize respective points 226 of the wall 228 in a point cloud, the point cloud comprising a plurality of points 232 localized in two or three dimensional space. The points 226 may be defined about a local origin 218 of the sensor 222. Distance 230 to a point 226 may comprise half the time of flight of a photon of a respective beam 224 used to measure the point 226 multiplied by the speed of light, wherein coordinate values (x, y) of each point 226 depends both on distance 230 and an angle at which the respective beam 224 was emitted from the sensor 222. The local origin 218 may comprise a predefined point of the sensor 222 of which all distance measurements are referenced to (e.g., location of a detector within the sensor 222, focal point of a lens of sensor 222, etc.).

The sensor 222 may include a field of view shown by the triangle formed by the plurality of beams 224. Sensor 222 may collect distance measurements 230 within the field of view by emitting beams 224 at discrete angles across the field of view. The field of view of the sensor 222 may range from zero degrees (i.e., a sensor 222 which utilizes only a single beam 224) to 360°.

According to at least one non-limiting exemplary embodiment, sensor 222 may be illustrative of a depth camera or other TOF sensor configured to measure distance and generate point clouds, wherein the sensor 222 being a LiDAR sensor is not intended to be limiting. Depth cameras may project a plurality of beams 224 to measure distances 230 in two dimensions to produce depth imagery. Depth imagery may include a plurality of pixels, each pixel may comprise a color value (e.g., greyscale or RGB color value) and a depth measurement. The measurement plane formed by beams 224 may illustrate one of a plurality of measurement planes of a depth camera.

According to at least one non-limiting exemplary embodiment, sensor 222 may be illustrative of a structured light sensor configurable to project a structured pattern of light onto wall 228. The size of the projected pattern may correspond to a distance between the sensor 222 and the wall 228. Deformations in the pattern may yield shape information of a surface of wall 228.

One skilled in the art would appreciate that a plurality of sensors 222, or other sensor units 114, may be positioned on a robot 102 chassis to enhance the navigation and localization capabilities of the robot 102. These sensors 222 may be mounted in static positions (e.g., using screws, bolts, etc.) or may be mounted with servomotors configured to adjust a pose of the sensor 222. Calibration of these sensors 222 may be essential for a robot 102 to navigate through an environment safely and perform complex tasks with high precision. Calibration of these sensors 222 requires knowledge or measurement of a pose of the sensors 222 on the robot 102, specifically the value of each sensor transform matrix 216 for each sensor unit 114. Poses of sensors 222 may degrade or change over time due to, for example, wear and tear, collisions with objects or people, vibrations, and/or electrical components of the sensor performing abnormally due to, e.g., temperature fluctuations. Accordingly, the systems and methods disclosed herein may enable real time pose estimation of sensors 222 for use in calibrating the sensors 222, or other exteroceptive sensor units 114 capable of generating point clouds.

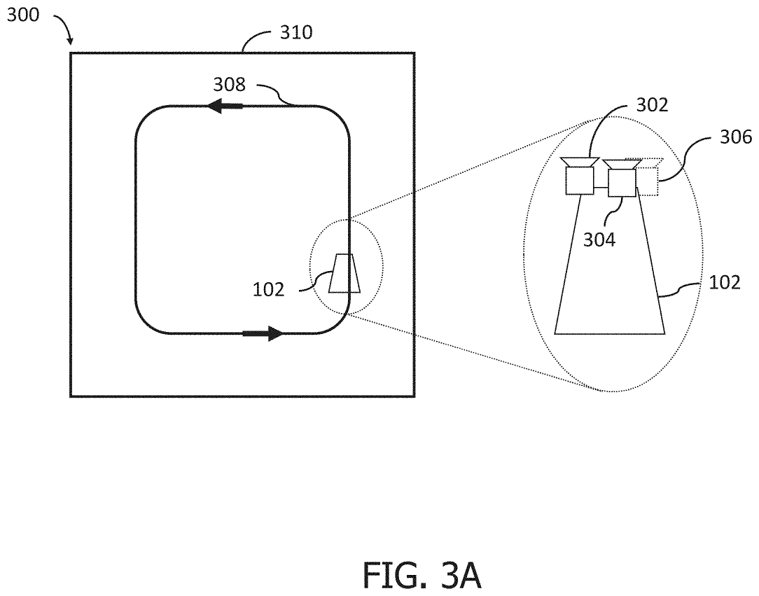

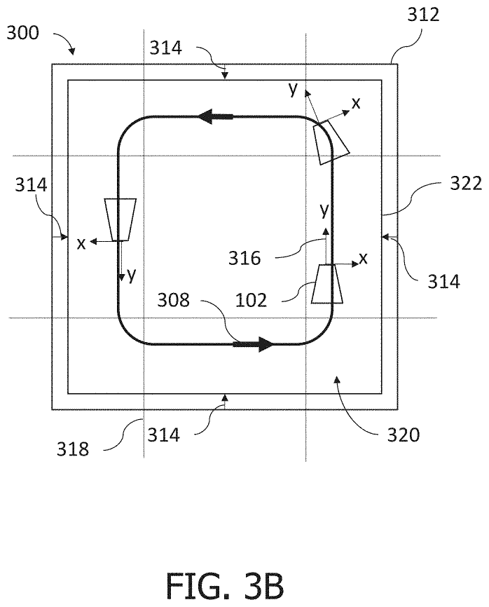

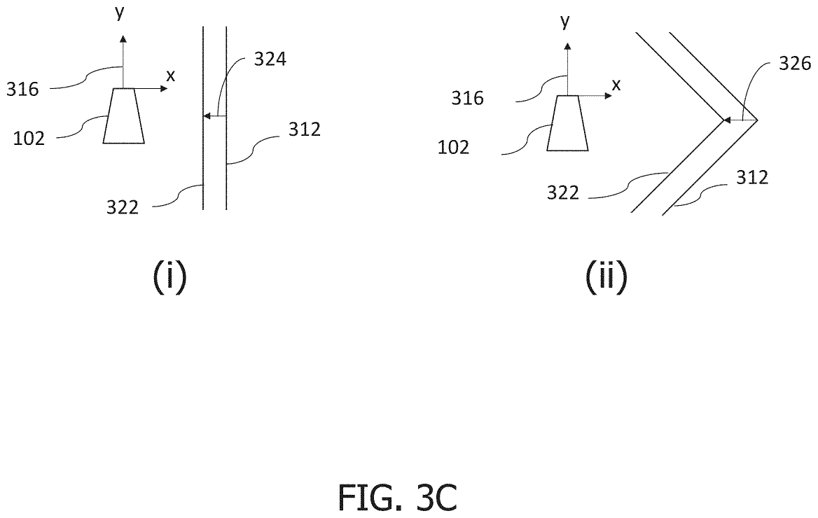

FIG. 3A illustrates a square environment 300 comprising a robot 102 surrounded by walls 310, according to an exemplary embodiment. FIG. 3A is illustrative of a ground truth (i.e., actual) position of the walls 310 surrounding the robot 102 for later reference to FIG. 3B-C. The robot 102 may comprise two distance measuring sensors 302 and 304 configured to measure a distance between the respective sensors and an object, in this embodiment the object comprises the walls of environment 300. Sensor 302 may be configured in a default (i.e., ideal) position on the robot 102, wherein sensor 304 may comprise some error in its position, as illustrated by its respective default position 306 (dashed lines) being different from its actual illustrated position 304 (solid lines). Due to the error in the pose of the sensor 304, the robot 102, as it navigates along route 308, may collect two set of localization data of the square walls as illustrated next in FIG. 3B from each sensor 302 and 304 which will comprise some discrepancy 314, as illustrated next in FIG. 3B. The two sensors 302 and 304 being in a forward facing direction is purely illustrative and not intended to be limiting, wherein the sensors 302 and 304 may be configured in any pose on the robot 102. The field of view of the two sensors 302 and 304 may be zero degrees (i.e., a directional LiDAR with only one beam 140) up to 360°. However, both sensors 302, 304 must sense the walls 310 at least in part in order to calibrate the misaligned sensor 304.

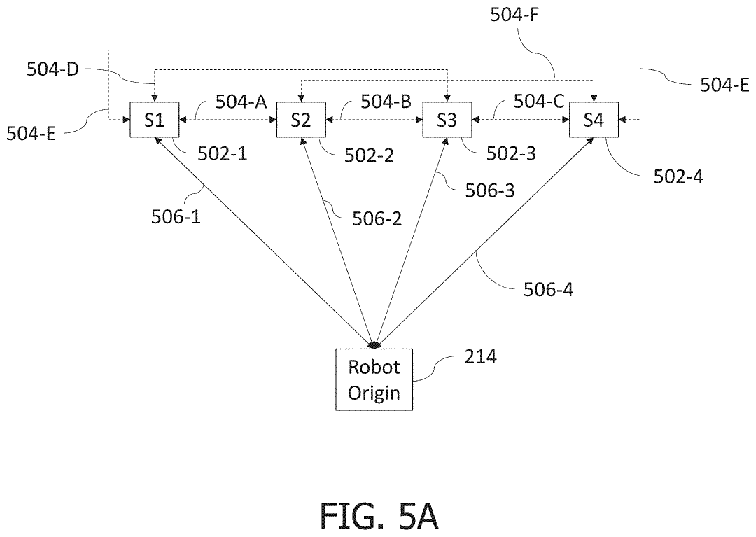

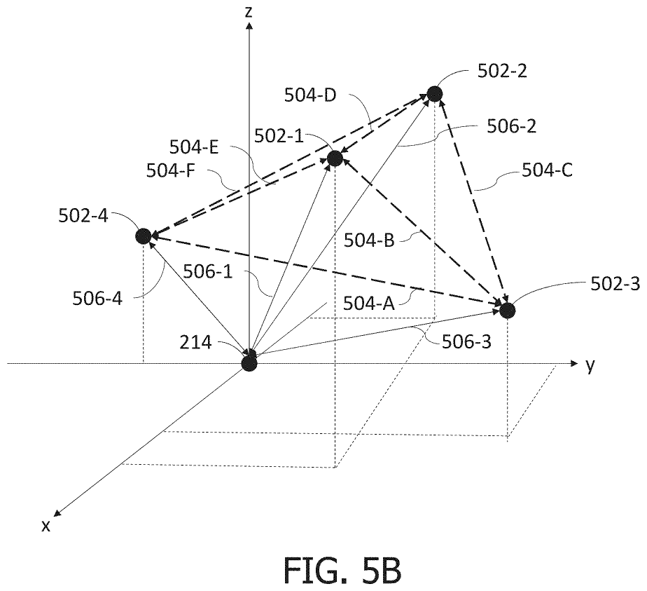

It will be presumed that sensor 302 comprises a rigidly mounted sensor such that the controller 118 may assume the sensor 302 is in its default pose for the purposes of describing the methods performed in FIG. 3B-C below. For example, sensor 302 may be coupled to the robot 102 using multiple screws, bolts, latches, etc. whereas sensor 304 may be mounted using less rigid means such that it is more susceptible to deviating from its default position. The present disclosure provides systems and methods for determining poses of two or more sensors on a robot 102 without this assumption, as will be discussed below in FIG. 5A-B.

FIG. 3B illustrates a computer-readable map generated by the robot 102, depicted in FIG. 3A above, navigating within the environment 300 and localizing surrounding walls 310 using two distance measuring sensors 302 and 304, according to an exemplary embodiment. The sensor 302, attached to the robot 102 in its default position, may localize the square walls 310 at locations of measurements 322 whereas the sensor 304, not mounted in its default position 306, may localize the walls 310 at locations illustrated by measurements 312, wherein the discrepancies 314 may arise due to a discrepancy in the pose of sensor 304 from its default pose 306 as illustrated in FIG. 3A. It is appreciated that the localizations 312, 322 of the walls are calculated by the controller 118 initially presuming both sensors 302, 304 are in their respective default positions (i.e 302 and 306), wherein the measurements 312 and 322 should align if both sensors are in their respective default positions. If the measurements 312 and 322 do not align, the controller determines that one of the sensors 302 or 304 is in a non-default position. To illustrate, due to the leftward shift of sensor 304 shown in FIG. 3A, the sensor 304 generates larger distance measurements to the walls on the right side of the robot 102 (i.e., +x direction in base link coordinates 316), thereby causing the controller 118 to map the location of the wall as being further away from the location the sensor 302 senses the wall.

For the purposes of explanation only, controller 118 may assume sensor 302 is well-calibrated and in its default position, wherein FIG. 5A-B below discuss a method for calibrating two or more sensors without this assumption. Measurements 322 and 312 may further comprise a plurality of localized points (i.e., point clouds) such that scan matching may be performed to determine a transformation which transforms measurements 312 to match measurements 322, wherein the measurements 322 and 312 have been illustrated using solid lines for clarity. This transformation, however, may comprise a nonisometric transformation (i.e., nonrigid) when determined within the world frame 202, wherein a nonisometric transformation may not yield insightful pose data for a pose of the sensor 304.

For example, when viewed in the world frame 202 (i.e., as illustrated), discrepancies 314 of just the rightmost wall may indicate that sensor 304 is mispositioned to the right of its default pose 306. However, discrepancies 314 of the leftmost wall may indicate that sensor 304 is mispositioned to the left of its default pose 306 when viewed from the world frame. That is, there is no possible isometric translation or rotation of the measurements 312 which causes measurements 312 to agree with measurements 322, wherein scaling (i.e., shrinking measurements 312 to match 322) the measurements 312 to measurements 312 may not correspond to any change in the sensor 304 pose from its default pose 306.

To determine an isometric transform to data from the sensor 304 such that the transformed data matches expected data from the sensor 304 at pose 306 (i.e., configures measurement 312 to match 322), the computer-readable map may be discretized by lines 318 into a plurality of regions 320, each comprising a predetermined number of points therein or a predetermined size (e.g., in square feet, meters, etc.). The measurements 322 and 312 of each region 320 may then be localized within a base link frame 212 of the robot 102 based on a position of the robot 102 as the robot 102 navigates route 308. Within the base link frame 212, defined using coordinates 316 illustrated, the discrepancies 314 may be constant and isometric between the measurements 312 and 322, wherein applying a scan match transform yields an isometric transformation which configures measurements 312 to match measurements 322 as illustrated next in FIG. 3C. It is appreciated that the map may be discretized into regions 320 such that a scan match may be performed using enough points to yield accurate data while imposing a maximum number of points for each scan match of each region 320 based on computational resources or time available to a controller 118.

FIG. 3C(i-ii) illustrates scans taken at various regions 320 of the environment 300 illustrated in FIG. 3B above, localized within a base link frame 212 of a robot 102, according to an exemplary embodiment. First, depicted on the left in FIG. 3C(i), are scans 322 and 312 taken by respective sensors 302 and 304 of a wall of the environment 300, wherein the scans may comprise scans taken while the robot 102 is positioned at a top center, left center, right center, or bottom center region 320 depicted in FIG. 3B. Similarly, depicted on the right in FIG. 3C(ii), are scans 322 and 312 of a portion of the wall taken when the robot 102 navigates within a top left, top right, bottom left, and/or bottom right regions 320 of the environment 300. Since these regions have been redefined with respect to the base link origin of the robot 102 and due to the symmetry of the square environment, these regions all appear similar, however in real asymmetrical environments this may not always be the case.

The scans of FIG. 3C(i) and 3C(ii) may comprise discrepancies 324 and 326, respectively, wherein discrepancies 324 and 326 comprise a same discrepancy value and direction (e.g., both comprise translation of measurements 312 along −x direction by 5 centimeters) within the base link frame 212. That is, both discrepancies 324 and 326 comprise a same magnitude (e.g., 5 centimeter discrepancy) and direction (i.e., along −x direction), thereby making discrepancies 324 and 326 isometric when measured within the base link frame 212. Described in another way, discrepancies 314 between scans 312 and 322 when viewed in the world frame in FIG. 3B may point in all directions (e.g., up, down, left, and right), whereas the same discrepancies 314 when viewed in the base link frame 212 point in the same direction as shown by discrepancies 324 and 326 pointing in the same direction.

Stated another way, as the robot 102 navigates route 308, illustrated in FIG. 3B above, the robot 102 may always localize the walls on its right side (i.e., positive x direction defined by coordinate axis 316) in the base link frame 212 such that the discrepancy 322 and 324 always comprises a translational shift of measurements 312 leftwards (i.e., along negative x direction) to match measurements 322. The leftwards translation may correspond to a leftward misposition of the sensor 304 from its default pose 306 as illustrated above in FIG. 3A.

Discretization of the environment 300 on a computer-readable map using a grid 318 as illustrated in FIG. 3B above may enhance the scan matching by limiting a number of points considered during scan matching to determine transformations 324 or 326. Limiting the number of points for the scan matching transformation may reduce a computational load imposed on a processing device 138 (e.g., of controller 118) performing the scan matching. It is appreciated that the size of the regions 320 may be further configured such that enough points 226 of measurements 322 and 312 are encompassed as use of only a few points 226 (e.g., on the order of 10 points) may cause the scan matching to yield unreasonable (e.g., noisy) results for transformations 322 and 324. Accordingly, one skilled in the art may determine the size of the regions 320 based on (i) computational recourses (e.g., processor clock rate, number of available threads, etc.) available to perform a scan matching; (ii) resolution of the sensors 302, 304; and (iii) accuracy of a determined scan match transform.

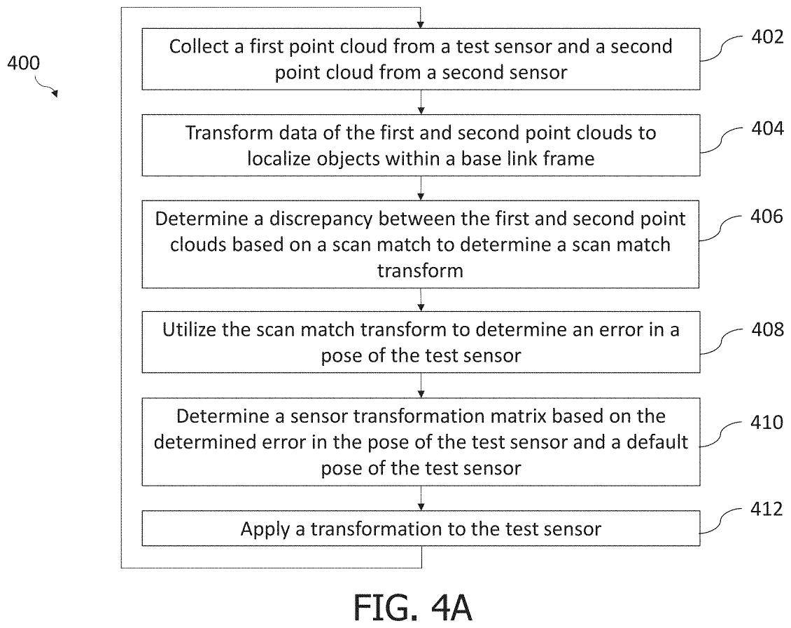

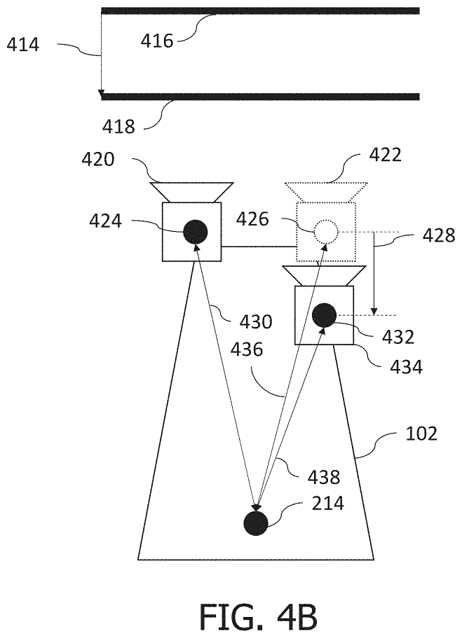

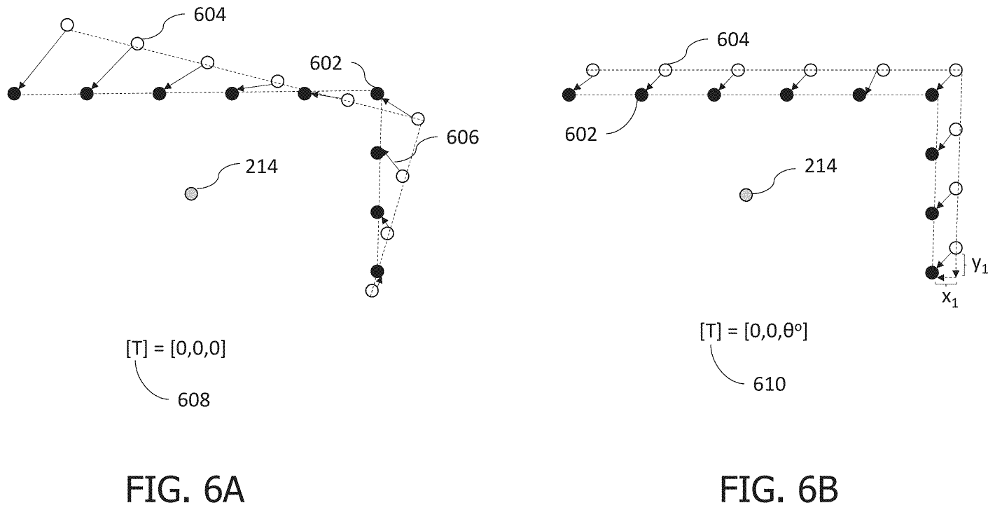

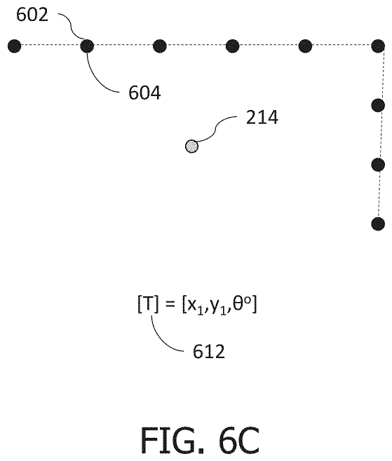

Scan matching of measurements 312 to match to measurements 322 may yield a transformation matrix comprising a spatial transformation which configures the measurements 312 to match the measurements 322 (i.e., transformation 324 and 326) via rotations and/or translations. This spatial transformation may correspond to a discrepancy in a pose of the sensor 304 from a default pose 306. Using the known default pose 306 of the sensor 304 (i.e., a constant predetermined value) and a deviation from the default pose (i.e., the spatial transformation based on discrepancies 324, 326 measured using scan matching), the pose of the sensor 304 may therefore be determined with respect to its default pose 306. Accordingly, a sensor transformation 216, comprising a spatial transformation from an origin 214 of the base link frame 212 to an origin 218 of the sensor 304, may be determined. An exemplary method for performing scan matching to determine discrepancies 324, 326 is further illustrated below in FIG. 6A-C. FIG. 4B below illustrates how discrepancies 324, 326 may correspond to a change in pose of the sensor 304 and how a sensor transformation 216 may be determined therefrom. It may be appreciated by one skilled in the art that use of a base link reference frame 212 to perform the scan matching to determine transformations 322 and 324 is necessary as no isometric transformation may be determined within the world frame 202 in most instances. Similarly, scan matching data within a local reference frame 220 defined about, for example, a local origin 218 of sensor 302, may yield a transformation matrix corresponding to a discrepancy in the pose of sensor 302 and sensor 304, rather than sensor 304 and its default pose 306, which may be of use during calibration of multiple sensors as illustrated in FIG. 5 below. Based on the determined sensor transformation matrix 216, a digital transformation may be applied to measurements 312 from the sensor 304 such that the measurements 312 may appear to be measured by the sensor 304 at its default pose 306 and agree with measurements 322 of the well calibrated sensor 302.

FIG. 4A is a process flow diagram illustrating a method 400 for a controller 118 of a robot 102 to determine a pose of a test sensor (e.g., sensor 304) and apply a digital transformation to the test sensor based on the pose of the test sensor deviating from a default pose (e.g., pose 306), according to an exemplary embodiment. Any steps of method 400 performed by the controller 118 comprises the controller 118 executing instructions from a memory 120 illustrated in FIG. 1A above. Method 400 configures the controller 118 to determine a pose of the test sensor and correct data from the test sensor if the pose deviates from its default pose.

Block 402 illustrates the controller 118 collecting a first point cloud from the test sensor and a second point cloud from a second sensor (i.e., at least one other sensor) of the robot 102, the second sensor may comprise a well-calibrated senor at its default pose. That is, the controller 118 may assume the second sensor is configured in its default pose. This assumption is removed in FIG. 5A-B below. The test sensor and the second sensor are configured to measure distances based on localizing a plurality of points (e.g., point clouds) and may comprise, for example, LiDAR sensors or depth camera sensors. The first or second point clouds may comprise point clouds generated based on, for example, a planar scan as illustrated in FIG. 2B, a plurality of one dimensional (i.e., line of sight) scans as the robot 102 moves, or a two dimensional scan (e.g., from a depth camera or 2D LiDAR), or multiple planar or two dimensional scans. The first scan from the test sensor and the second scan from the second sensor comprising points localizing an object, the object being present in both scans (e.g., walls of environment 300 illustrated in FIG. 3 above). Both point clouds comprise localization data of the object defined about an origin 214 of a base link frame 212 or an origin 208 of a world frame 202, wherein the two scans may comprise some discrepancy within these reference frames due to an error in a pose of the test sensor.

Block 404 illustrates the controller 118 transforming data of the first and second point clouds to localize points of the point clouds within a base link frame 212, defined about a predefined origin 214 of the robot 102. Redefining the origin of measurements from the world frame 202 to the base link frame 212 comprises controller 118 utilizing a position of an origin 214 the robot 102 during capture of the scans to determine a transformation 210, as illustrated in FIG. 2A above. Accordingly, navigation units 106 may continuously localize an origin 214 of the robot 102 within its environment with respect to an origin 208 of a world frame 202 as the robot 102 utilizes the test sensor and second sensor to collect the first and second scans.

According to at least one non-limiting exemplary embodiment, the first point cloud and second point cloud may be discretized into a plurality of regions 320 as shown in FIG. 3B. Each of these regions 320 may include a predefined enclosed area (e.g., 1×1 feet). Each of these regions 320 of the first and second point clouds may be transformed to be redefined about an origin 214 of the base link frame 212 based on one or more positions of the robot 102 during acquisition of distance measurements within these regions 320, as shown in FIG. 3C.

Block 406 illustrates the controller 118 determining a discrepancy between points of the first point cloud and points of the second point cloud representing the same object, the discrepancy being measured based on a scan matching. The scan matching may comprise, for each point of the first point cloud, determining a nearest corresponding point of the second point cloud representing the same object and spatially transforming the points of the first point cloud to match the nearest neighboring points of the second point cloud, wherein the spatial transformation corresponds to the measured discrepancy. Controller 118 may execute algorithms such as pyramid scan matching or iterative closest point (ICP) to perform the scan matching. The spatial transformation determined by the scan matching may comprise a scan match transform 612, as illustrated below in FIG. 6, comprising a spatial transformation which aligns points measured by the test sensor with points measured by the second sensor.

Block 408 illustrates the controller 118 utilizing the scan match transform to determine an error in a pose of the test sensor. The scan match transform, comprising a spatial transformation which configures localized points of the first point cloud to match localized points of the second point cloud, may correspond to a deviation of the test sensor from its default pose, wherein the test sensor positioned at the default pose may generate a first point cloud identical to the second point cloud of the object within the base link frame 212 and/or world frame 202. The pose of the test sensor may therefore be determined based on the determined deviation from the default pose of the test sensor.

Block 410 illustrates the controller 118 determining a sensor transformation matrix 216, comprising a spatial transformation of coordinates from the base link frame 212 to local coordinates 220 of the test sensor, based on the determined error in the pose of the test sensor and the known default pose of the test sensor. For example, the scan match transform may indicate the pose of the test sensor comprises an error of five centimeters along an x axis (e.g., using reference coordinates 316 of FIG. 3B-C) from a default pose. Accordingly, the pose of the test sensor may comprise the default pose plus (or minus) the five centimeter error. The pose of the sensor may be utilized to determine a transformation 216 between the origin 214 of the base link frame 212 to the origin 218 of the test sensor.

Block 412 illustrates the controller 118 applying a transformation to the test sensor. The transformation may comprise a digital transformation or a physical adjustment of the sensor. The digital transformation may comprise an adjustment to the incoming data (i.e., (x, y, z) position of points arriving from the test sensor such that the arriving data localizes objects at a same position as the second sensor. Following the above example in FIG. 3C, wherein the test sensor (304) comprises a five centimeter error along an x-axis, the digital transform may comprise adjusting all localization data of all points (312) measured by the test sensor by five centimeters along the x-axis. One skilled in the art may appreciate that the digital transforms may further comprise transforming localized data values or points along any of y, z, roll, pitch, and/or yaw axis. The physical adjustment may comprise an actuator or human adjusting a pose of the test sensor to match a default pose, the adjustment being based on the sensor transformation matrix (i.e., deviation from the default pose).

One skilled in the art may appreciate that method 400, or portions thereof, may be repeated at later times using multiple pairs of first and second scans to measure a pose of a test sensor at the later times. Additionally, the determined pose of the test sensor may be further utilized to determine additional transformations 504 between local reference frames 220 of the test and second sensors as illustrated below in FIG. 5. These additional transformations 504 in conjunction with measuring the pose of the test sensor multiple times over time, may yield further improvement to the determined pose of the test sensor.

FIG. 4B illustrates controller 118 of a robot 102 executing method 400 illustrated above to determine a sensor transformation matrix 438 corresponding to a spatial transformation from an origin 214 of a base link frame 212 to an origin 432 of a sensor 434, the sensor 434 comprising some error 428 in its pose, according to an exemplary embodiment. Sensors 420 and 434 may comprise exteroceptive sensors of sensor units 114 configurable to localize objects and represent the objects and their locations in a point cloud. In this illustrated embodiment, sensor 420 is at a default position such that measurements 418 from the sensor 424 comprise no error. The robot 102 may collect two scans 416 and 418 of a surface or object (e.g., a wall) using sensors 434 and 424, respectively, in which scan 418 is indicative of the actual position of the wall relative to the robot 102. If sensor 434 was at its default pose 422, scan 416 would yield no discrepancy 414 when compared to scan 418. That is, scans from sensors at poses 420 and 422 would be coincident (discrepancy 414 would equal zero) and both scans would correctly localize the wall at 418. Due to the sensor 434 comprising some error 428 in its pose with respect to its default pose 422 (dashed lines), the two measurements 416 and 418 may comprise some discrepancy 414. Sensor 434, being further from the wall, generates larger distance measurements to the wall thereby causing the controller 118 to localize the wall at a location 416 further from the location 418 measured by the calibrated sensor 420. Scan matching of individual points of the measurements 416 may yield a scan match transform corresponding to the discrepancy 414. This scan match transform may further correspond to the error 428 in the pose of the sensor 434, as illustrated by arrows 414 and 428 being of the same length and direction. More specifically, the error 428 and discrepancy 414 corresponds to a change in position of the origin 432 of the sensor 434 from its default position 426.

It is appreciated that the default positions 424 and 426 of both sensors 420 and 422, respectively, are known by a controller 118 of the robot 102. For example, a manufacturer of the robot 102 may specify these default positions and communicate their values to the controller 118 to be stored in memory 120. Based on the error 428, determined by the scan matching of measurements 416 to match 418 within the base link frame 212, the sensor transformation matrix 438 may be determined. The sensor transformation matrix 438 corresponds to a position of the origin 432 of the sensor 434 with respect to the origin 214 of the base link frame 212 (i.e., origin of the robot 102), wherein the sensor transformation matrix 438 may be further utilized to determine digital transformations to data from the sensor 434 to correct measurements 416 such that measurements 416 match measurements 418 taken by the sensor 420, sensor 420 being at its default pose. For example, in this embodiment, the digital transform may comprise translating all points of measurement 416 downward along a vertical axis such that they match measurements 418 which, in turn, corresponds to a downward translation of origin 432 of sensor 434 from its default position 426.

According to at least one non-limiting exemplary embodiment, error 428 may be further utilized by a controller 118 of a robot 102 to determine control signals to one or more actuators or servomotors configured to adjust a pose of sensor 434 such that the error 428 is minimized.

It is appreciated that the systems and methods disclosed above enable a test sensor to be calibrated using a second sensor as a reference, wherein the second sensor is presumed at its default position. In some embodiments, one sensor of a robot 102 may be well calibrated (e.g., using other calibration methods, using redundant verification of calibration, robust mounting of the sensor to the robot 102, etc.) and provide a reference sensor to determine poses of other sensors of the robot 102 using method 400. In other embodiments, a second sensor comprising a known position may not be available. Illustrated below are systems and methods for determining poses of multiple sensors on a robot 102 which are not reliant on one sensor being at a default or otherwise known position.

FIG. 5A illustrates a functional block diagram of a system configured to determine poses of multiple sensors 502 of a robot 102 with respect to a robot origin 214 of a base link frame 212, according to an exemplary embodiment. Each sensor 502 may comprise a sensor of sensor units 114 configured to measure distance and/or produce a point cloud (e.g., LiDAR sensors, depth camera sensors, etc. shown in FIG. 2B above). A controller 118 of the robot 102 may utilize method 400 to determine a plurality of sensor transformation matrices 506, corresponding to a spatial transformation from the robot origin 214 to a local origin 218 of each sensor 502 (i.e., similar to transformation 216 illustrated in FIG. 2). The controller 118 may determine, for example, three sensor transformation matrices 506-1 for sensor 502-1, comprising spatial transformations from the robot origin 214 to a local origin 218 of sensor 502-1, using the other three sensors 502-2, 502-3, and 502-4 as “second sensors” in the method 400 (assuming each to be at their respective default poses) and the sensor 502-1 as the “test sensor” (i.e., perform method 400 three times, excluding block 412), wherein transformation 506-1 may comprise an average of the three sensor transformation matrices. The controller 118 may repeat this method 400 to determine transformations 506-2, 506-3, and 506-4 to respective sensors 502-2, 502-3, and 502-4 from the robot origin 214.

By way of illustration, the controller 118 may utilize sensor 502-1 as a “second sensor” in method 400 and calculate transformations 506-2, 506-3, and 506-4 using respective sensors 502-2, 502-3, and 503-4 as “test sensors”. Subsequently, the controller 118 may utilize sensor 502-2 as the “second sensor” in method 400 and calculate transformations 506-1, 506-3, 506-4, using respective sensors 502-1, 502-3, and 502-4 as “test sensors”. This may continue for each of the four sensors 502 illustrated. Accordingly, the controller 118 may receive four different sets for each transform 506-1, 506-2, 506-3, and 506-4, wherein pose graph optimization may be utilized to configure the four sets of transforms 506-1, 506-2, 506-3, and 506-4 to agree on poses for the four sensors 502-1, 502-2, 502-3, and 502-4. Stated differently, sensor 502-1 may be utilized as a “test sensor” wherein the transform 506-1 (calculated in block 412) is calculated three times using sensors 502-2, 502-3, and 502-4 as the “second sensor” in method 400 to provide three values for transform 506-1. In some embodiments, transforms 504 are calculated during execution of method 400 upon determining a pose of the “test sensor”, wherein the transforms 504 may include a spatial transform from a default pose of the “second sensor” and the determined pose of the “test sensor”.

Transformations 504 may comprise spatial transformations from a local origin 218 of a sensor 502 to local origin 218 of a different sensor 502, wherein the positions of the local origins 218 of the sensors 502 are inferred based on transformations 506. That is, the system illustrated may correspond to a pose graph of sensor poses on the robot 102 defined with respect to robot origin 214. A controller 118 or other processing device may perform a pose graph optimization given a set of constraints on the determined poses of all sensors 502 such that all transformations 504 and 506 agree on a pose for each sensor 502. The set of constraints may denote realistic limits on errors in calibration such that the pose graph optimization yields realistic results (e.g., a LiDAR sensor cannot be mispositioned by 15° or more). For example, upon performing the pose graph optimization, following a transformation 506-4 to determine a pose of sensor 502-4 may yield a same pose as following a transformation 506-3 then 504-C to determine the pose of sensor 502-4. Similarly, transformation 506-1 should agree with transformations 506-2, 504-B, and 504-D, in that order, for a pose of sensor 502-1, and so forth. Further, due to transformations 506 configuring point clouds of all sensors 502 to match in accordance with method 400 above, measurements from each respective sensor 502 may match with measurements from all other sensors 502. That is, pose graph optimization may determine optimal poses for each sensor 502 based on measured sensor transformation matrices 506 and inferred transformation matrices 504 may determine poses for each sensor 502 such that all transformations 506 and 504 agree on a pose for each sensor 502.

Constraints may be imposed on the transformations 506 and 504 such that the determined poses of the sensors 502 are reasonable. For example, a constraint may be imposed on a sensor 502-1 indicating that the sensor 502-1 may not deviate from its default pose by more than five centimeters translationally or 15° angularly along any axis due to a method of mounting the sensor 502-1 to the robot 102 (e.g., the sensor 502-1 may be mounted with screws wherein a translational error in pose of five centimeters or more is not within reasonable physical constraints). That is, the constraints are based on reasonable physical constraints on poses of the sensors 502. If a one or more transformations 504 or 506 to a sensor may not be determined within the imposed constraints, the sensor may be determined to require further manual adjustment by an operator of the robot 102.

Given a limited amount of data, such as a point cloud of a single region 320 shown in FIG. 3B, the controller 118 may determine the poses of the four sensors to be slightly different from reality, though data from each sensor localizes objects at the same locations. As more data is collected and additional shapes, corners, and other features of the environment are sensed, the pose graph optimization process is provided with additional data to constrain its result to values closer to reality. Although there is no guarantee that the exact values of the sensor transforms 504, 506 will match exactly with the true value of these transforms 504, 506, any small error in the determined pose is allowable due to (i) continuous reduction of the error as the robot 102 senses more objects, further constraining the pose graph optimization; and (ii) all of the sensor data agreeing to the location of an object, even if the true location is off by a small amount. Use of the pose graph optimization is not intended to detect/correct large errors in calibration but rather to maintain and continuously update the poses of the sensors.

Digital transformations may be applied to data from one or more sensors 502 based on the determined spatial transformations 506 such that data from all sensors 502 agree. That is, each sensor 502 should localize an object within a world frame 202 and base link frame 212 at a same location as other sensors 502 viewing the same object, wherein the digital transformations applied may configure the localization data of the object from each sensor 502 to match. Advantageously, the system illustrated may enhance calibration of sensors 502 of a robot 102 by enabling all sensors 502 to be calibrated in real time with respect to each other. Additionally, if one sensor cannot be determined to be in its default pose (i.e., all sensors assumed to comprise some error in their poses), the constraints imposed on transformations 504 and 506 may further enhance diagnostic capabilities of a controller 118 to detect if one or more sensors 502 require calibration by an operator due to the one or more sensors 502 deviating from its default pose significantly (i.e., beyond the constraints).

According to at least one non-limiting exemplary embodiment, each transformation 504 and/or 506 may be measured over periods of time, wherein values of the transformations 504 and 506 may correspond to an average (e.g., weighted or unweighted) over time of a pose of a sensor 502 with respect to a robot origin 214 of a base link frame. For example, a controller 118 may determine spatial transformations 506 using every pair of scans or a select pair of scans (e.g., two scans every ten scans taken) taken by a first sensor 502 and second sensor 502, the first and second sensor 502 corresponding to any pair of exteroceptive sensor units 118.

One skilled in the art may appreciate that a sensor 502 may be at its default pose on a robot 102, wherein the pose graph optimization may output a pose of the sensor 502 different from the default pose. Pose graph optimization may require a large sample set of data to yield an accurate pose estimation for the sensors 502. The large sample set may be acquired by controller 118 over a period of time as sensors 502 collect scans of an environment, wherein the pose estimation determined by the pose graph optimization may become increasingly accurate as the robot 102 operates. For example, using only a single scan from a first and second sensor 502 may yield a plurality of degenerate poses for the first and second sensor 502. However, upon collecting multiple scans, some or all but one of these degenerate poses may be determined to be incorrect and omitted based on the pose graph optimization.

FIG. 5B illustrates the pose graph illustrated in FIG. 5A in three-dimensional space, according to an exemplary embodiment. Each sensor 502 is represented by a dot or point corresponding to a location in three-dimensional space of a respective local sensor origin 218 of each sensor 502. Transformations 506, corresponding to a spatial transformation between a robot origin 214 of a base link frame 212 and a respective sensor origin 218 of each sensor 502, may be determined for any sensor 502 following method 400 above using the other sensors 502 as the “second sensor”. For example, transformation 506-3 between origin 214 and sensor 502-3 may be determined by controller 118 of a robot 102 executing method 400 three times using sensor 502-3 as the “test sensor” and, during each execution of method 400, using one of the other remaining sensors 502-1, 502-2, 502-4 as the “second sensors”, wherein the transformation 506-3 may comprise an average of the three sensor transformation matrices 216 determined using method 400. Using the transformations 506, determined using method 400, the controller 118 may then determine transformations 504 comprising spatial transformations between local origins 218 of each sensor 502 with respect all other local origins 218 of all other sensors 502.

Using a pose graph optimization based, in part, on constraints imposed by an operator or manufacturer of the robot 102, transformations 504, transformations 506, and default poses of each sensor 502, the controller 118 may optimize digital transformations applied to each sensor 502 such that: (i) all measurements from every sensor 502 of a same object agree with each other (i.e., no discrepancy 314 exists, as illustrated in FIG. 3B above), (ii) each local origin 218 of each sensor 502 is within reasonable constraints, and (iii) minimizes a strength of the applied digital transformations. A strength of an applied digital transformation corresponds to an amount or magnitude of manipulation performed by the digital transformation on data from a sensor 502.

It is appreciated that the constraints on the pose graph optimization imposed by the operator or manufacturer may comprise small constraints (e.g., ±5°, ±2 cm, etc.) as the digital transformations applied to the sensors 502 may only correct measurements acquired by the sensors by a small amount. The constraints correspond to reasonable values of a deviation of a pose of a sensor from its default pose. Correcting the measurements by a small amount, however, may greatly enhance navigation and task performance by the robot 102 when the robot 102 is performing tasks requiring high precision. For example, a cleaning robot 102 may require its sensors to be highly calibrated to navigate safely close to walls, wherein even slight misperception of a location of the walls may cause a collision or cause the cleaning robot 102 to miss floorspace near the walls. In another example, a robot 102 may be required to manipulate small objects, wherein accurate perception of a location of the small objects may require highly accurate calibration of sensors 502, which may be achievable by digital transformations. It is additionally appreciated that small angular errors in sensor pose from a default pose may cause the error to compound when measuring far distances or localizing objects along long routes. Reducing the compounding error may further enhance accuracy of maps of an environment surrounding the robot 102 as the maps may comprise objects detected substantially far from the robot 102.

FIG. 6A illustrates two sets of scans from two separate sensors, each set of scans comprising a plurality of points 602 or 604, to illustrate a process of scan matching to determine a scan match transform matrix 612, according to an exemplary embodiment. The scans may comprise localization of a plurality of points 602 and 604 (e.g., points 226 of FIG. 2B above) within a base link frame 212, each point may correspond to a measurement beam of a LiDAR or other distance measuring sensor (e.g., depth camera) localizing a surface of an object, as illustrated in FIG. 2B above. Points 602 may be measured by a first sensor and points 604 may be measured by a second sensor. Points 602, 604 may similarly be illustrative of two sequential scans from a same sensor, wherein the discrepancy in the location of the points 602, 604 may correspond to movement of the robot 102. A contour of a surface of an object of which the two sets of points 602, 604 localize is illustrated using dashed lines for clarity, wherein the object may comprise, without limitation, a corner of a wall (e.g., wall 310).

To perform the scan matching of points 604 to match points 602, a controller 118 may determine, for each point 604, a nearest neighboring point 602 using specialized algorithms (e.g., 2 or 3 dimensional iterative closest point (2D/3D ICP), K-nearest neighbor, etc.). The nearest neighboring point 602 for each point 604 is illustrated by a spatial transform 606 for each respective point 604 corresponding to a spatial transform which configures point 604 to match with its nearest neighboring point 602. The scan matching may comprise determining transformations of the set of points 604 which includes rotation as well as translation. The rotation being about the origin 214 of the base link frame 212. In order to minimize the transforms 606, the controller 118 may first perform a rotation of the points 604 by an angle θ° about the base link frame origin 214, as shown next in FIG. 6B. Transformation 608 includes no translations along x or y axis and no rotations in FIG. 6A.

In FIG. 6B, the set of points 604 have been rotated such that each point 604 comprises a same spatial transformation 610 to each respective neighboring point 602, wherein the spatial transformation 610 may comprise a translation of points 604 to match points 602. The rotation of points 604 may comprise a rotation of θ°, as denoted by the scan match transform matrix 610 now comprising a rotational value of θ° in FIG. 6B and zero translation values along x and y axis. This translation 610, when executed by the controller 118, configures the series of points 604 to match the series of points 602 as illustrated in FIG. 6C.

As shown in FIG. 6C, the points 602, 604 overlap. The transformation 612 now includes translations (x₁, y₁) and the rotation of θ° performed by the controller 118 to align the set of points 604 with points 602. The values x₁ and y₁ may comprise positive, zero, or negative values.

The points 602 and 604 may comprise localization points of a same object taken by two sensors (e.g., sensors 302, 304 of FIG. 3A-C) and localized within a base link frame 212 such that the scan match transform 608 may correspond to errors in a pose of one of the sensors, in this embodiment the error is in a pose of the sensor which captures points 604. One skilled in the art may appreciate that two sensors localizing points 602 and 604 within a base link frame 212 may yield substantially similar or identical points 602 and 604, provided the two sensors are in their default (i.e., ideal) positions. That is, the scan match transformation matrix 608 may correspond to a spatial deviation of one of the sensors (i.e., in this case, the sensor used to capture points 604) from its default pose (e.g., error 428 illustrated in FIG. 4B) as both sensors at their default poses may localize objects within a base link frame 212 with identical, or substantially similar, sets of points 602 and 604.

According to at least one non-limiting exemplary embodiment, a scan match transformation matrix 612 may further comprise z, roll, and pitch parameters in addition to the x, y, and yaw parameters illustrated, wherein the additional parameters have been omitted for simplicity.

According to at least one non-limiting exemplary embodiment, the scan matching may first translate the points 604 and subsequently rotate the points 604. In some embodiments, a plurality of rotations and translations may be performed iteratively. The iterative process may include the controller 118 rotating points 604 by a small amount to decrease the spatial transformations 606. Next, the controller 118 may translate the points 604 by a small amount to decrease spatial transformations 606. The controller 118 may then rotate the point 604 by a small amount and repeat the iterative process until the spatial transformations 606 are a minimum or zero value. That is, the scan matching process is not intended to be limited to a single rotation followed by a single translation of points 604.

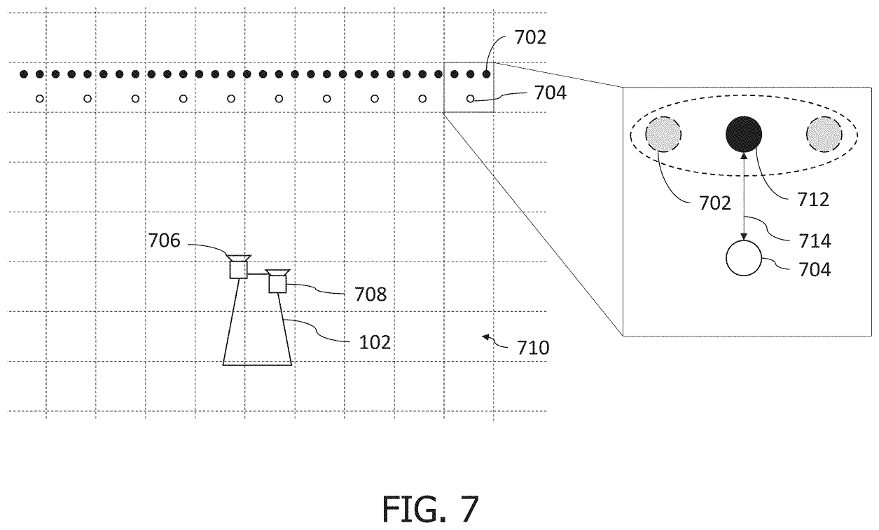

FIG. 7 illustrates a method for performing a scan matching of localized points 702, captured by a sensor 706, to points 704, captured by a sensor 708, wherein the two sensors 706 and 708 comprise a different spatial and/or angular resolution, according to an exemplary embodiment. Use of a nearest neighbor algorithm for matching two sets of points of differing resolution may yield unreasonable scan match transformation matrices (e.g., scan match transform matrices exceeding prescribed constraints, nonisometric transformations, etc.). Accordingly, the computer-readable map of which the points 702 and 704 are localized within may be discretized into a plurality of regions 710 such that at most one point 704 of the lower resolution sensor 708 is within each region 710. All points 702 of the higher resolution sensor 708 within each region 710 may be averaged such that a mean point 712 may be determined. The mean point 712 may comprise an x coordinate value equal to the mean x coordinate value of all points 702 within the region 710, a y coordinate value equal to the mean y coordinate value of all points 702 within the region 710, and/or a z coordinate value equal to the mean z coordinate value of all points 702 within the region 710. Determining a mean point 712 for each region 710 may yield a set of mean points 712 corresponding to a down-sampled version of the original measurements 702. Accordingly, a scan match 714 between each point 704 and its nearest neighboring mean point 712 may be determined.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated for carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being redefined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to”. The term “example” or the abbreviation “e.g.” is used to provide exemplary instances of the item in discussion, not an exhaustive or limiting list thereof, and should be interpreted as “example, but without limitation”. The term “illustration” or related terms is used to provide exemplary instances of the item in discussion, not an exhaustive or limiting list thereof, and should be interpreted as “illustration, but without limitation;”. Adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robotic system, comprising:
a memory comprising computer-readable instructions stored thereon; and
a processing device configured to execute the computer-readable instructions to,
collect a first scan from a test sensor and a second scan from a second sensor, both the first and second scans comprising an object detected therein;
determine a discrepancy between the first and second scans by scan matching points of the object of the second scan to points of the object of the first scan, the scan matching being performed within a base link frame of reference;
determine a sensor transformation of the test sensor based on the determined discrepancy, the sensor transformation corresponding to a spatial transformation between an origin of the base link frame and an origin of the test sensor, the discrepancy corresponds to a change in pose of the test sensor from a default pose; and
apply a digital transformation to the test sensor based on the sensor transformation, the digital transformation configured to match measurements of the object obtained from the test sensor and the second sensor.

2. The robotic system of claim 1, wherein the processing device is further configured to execute the computer-readable instructions to,
activate one or more actuators coupled to the test sensor to adjust a pose of the test sensor based on the sensor transformation.

3. The robotic system of claim 1, wherein the processing device is further configured to execute the computer-readable instructions to,
determine a second sensor transformation for the second sensor based on the discrepancy, the second transformation comprising of a spatial separation between an origin of the base link frame and an origin of the second sensor;
determine a third transformation matrix between respective origins of the test sensor and the second sensor to generate a pose graph, the pose graph denotes positions of the respective origins of the test and second sensors with respect to the origin of the base link frame.

4. The robotic system of claim 3, wherein the processing device is further configured to execute the computer-readable instructions to,
perform a pose graph optimization to the pose graph to determine optimal poses of the test sensor and the second sensor with respect to the base link frame origin using a plurality of transformations measured over time.

5. The robotic system of claim 4, wherein,
the plurality of transformations comprise spatial transformations between at least one of:
the base link frame origin and a local origin of the test sensor,
the base link frame origin and a local origin of the second sensor, and
local origins of the test sensor and second sensor,
the pose graph optimizations configured to match measurements made by the test sensor and the second sensor to match.

6. The robotic system of claim 5, wherein the processing device is further configured to execute the computer-readable instructions to,
determine digital transformations to data from the first sensor and the test sensor based on the determined optimal poses from the pose graph optimization and deviation of the optimal poses from respective default poses of the test and second sensors.

7. The robotic system of claim 5, wherein the processing device is further configured to execute the computer-readable instructions to,
constrain the pose graph optimization by imposing threshold constraints to translational and rotational pose parameters of the test sensor and the second sensor, the threshold constraints corresponding to a threshold deviation from a default pose.

8. A method, comprising:
determining, via a controller of a robot, a sensor transformation matrix based on a scan matching between measurements of an object measured by a first sensor and a second sensor, the scan matching being performed within a base link frame of reference, the sensor transformation matrix comprising a spatial transformation between the base link frame and a local reference frame of the first sensor, the scan matching configured to align measurements by the first sensor to match measurements of the second sensor; and
applying, via the controller, a digital transformation to data arriving from the first sensor based on the sensor transformation matrix of the first sensor, the digital transformation configured to match measurements of the object obtained from the first sensor and the second sensor.

9. The method of claim 8, further comprising:
determining, via the controller, a pose graph based on at least one of the sensor transformation matrix of the first sensor, sensor transformation matrices of the second sensor, and a transformation between local origins of the first and second sensor;
optimizing, via the controller, the pose graph to determine a pose of the first sensor and a pose of the second sensor;
applying the digital transformation to the first sensor based on the pose of the first sensor determined by the pose graph optimization; and
applying a second digital transformation to the second sensor based on the pose of the second sensor determined by the pose graph optimization.

10. The method of claim 9, wherein,
the pose graph is updated upon a threshold amount of additional data being collected by the first sensor and the second sensor, the threshold amount corresponding to a number of points.

11. The method of claim 9, further comprising:
constraining the pose graph optimization by imposing threshold constraints to translational and rotational pose parameters of the test and second sensors, the threshold constraints corresponding to a threshold deviation from a default pose.

12. A non-transitory computer-readable storage medium comprising a plurality of computer-readable instructions stored thereon that, when executed by a controller of a robot, configure the controller to,
determine sensor transformation matrix based on a scan matching between measurements of an object measured by a first sensor and a second sensor, the scan matching being performed within a base link frame of reference, the sensor transformation matrix comprising a spatial transformation between the base link frame and a local reference frame of the first sensor, the scan matching configured to align measurements by the first sensor to match measurements of the second sensor; and
apply a digital transformation to data arriving from the first sensor based on the sensor transformation matrix of the first sensor, the digital transformation configured to match measurements of the object obtained from the first sensor and the second sensor.

13. The non-transitory computer-readable storage medium of claim 12, wherein the controller is further configured to execute the computer-readable instructions to,
determine a pose graph based on the sensor transformation matrix of the first sensor, sensor transformation matrices of the second sensor, and a transformation between local origins of the first and the second sensor;
optimize the pose graph to determine a pose of the first sensor and a pose of the second sensor;
apply the digital transformation to the first sensor based on the pose of the first sensor; and
apply a second digital transformation to the second sensor based on the pose of the second sensor determined by the pose graph optimization.

14. The non-transitory computer-readable storage medium of claim 9, wherein,
the pose graph is updated upon a threshold amount of additional data being collected by the first sensor and the second sensor, the threshold amount corresponding to a number of points.

15. The non-transitory computer-readable storage medium of claim 9, wherein the controller is further configured to execute the computer-readable instructions to,
constrain the pose graph optimization by imposing threshold constraints to translational and rotational pose parameters of the test and second sensors, the threshold constraints corresponding to a threshold deviation from a default pose.
